(19) United States
(12) Patent Application Publication
(10) Pub. No.: US 2017/0030250 A1
(43) Pub. Date: Feb. 2, 2017

(54) COMPACT COOLING MODULE

(71) Applicant: Hanon Systems, Daejeon (KR)

(72) Inventors: Marc Graaf, Krefeld (DE); Gerald Richter, Aachen (DE)

(21) Appl. No.: 15/223,016

(22) Filed: Jul. 29, 2016

(30) Foreign Application Priority Data
Jul. 29, 2015 (DE) 102015112379.7

(51) Int. Cl. F01P 3/18; F01P 5/02; B60K 11/04

(52) U.S. Cl. CPC F01P 3/18; B60K 11/04; F01P 5/02

(57) ABSTRACT

A compact heat exchanger and blower unit for motor vehicles, including a blower for the propulsion of an air mass flow with an inlet and an outlet, as well as a coolant-air heat exchanger with an air inlet and an air outlet. The blower, which is embodied as a radial blower, and the coolant-air heat exchanger are aligned with respect to each other such that the air mass flow is propelled by the blower into the coolant-air heat exchanger.

### CROSS-REFERENCE TO RELATED PATENT APPLICATION

This patent application claims priority to German Patent Application No. DE 102015112379.7 filed on Jul. 29, 2015, the disclosure of which is incorporated herein by reference in its entirety.

### FIELD OF THE INVENTION

The invention relates to a compact heat exchanger and blower unit for motor vehicles. The heat exchanger and blower unit features a blower with an inlet and an outlet for the propulsion of an air mass flow, as well as a coolant-air heat exchanger with an air inlet and an air outlet for the heat transfer between the coolant and the air mass flow.

### BACKGROUND OF THE INVENTION

Cooling modules for motor vehicles that are known from prior art consist of heat exchangers that are assembled into modules, such as a coolant cooler of a coolant circulation system, a refrigerant condenser of a refrigerant circulation system, a charge air cooler and/or an oil cooler, a blower, and a module holder. The cooling modules are preassembled and positioned in the front region of the engine compartment of the motor vehicle.

The air-charged coolant cooler of a coolant circulation system, also referred to as a radiator, features a very large front surface, with dimensions such as 800 mm×400 mm, for example, in order to achieve a satisfactory heat transfer, at a very low depth, for example of 40 mm. The front surface corresponds here to the inflow surface, whereas the depth dimension corresponds to the direction of the air inflow. The aspect ratio between the sides of the front surface and the depth is in the range of 10 to 20.

The electromotorically operated blower is generally embodied as an axial blower, in which axial blades are rotationally mounted as fans onto a driven hub. In the air flow direction, the blower is generally positioned behind the heat exchangers, and sucks in the ambient air through the heat exchangers. The rotation axis of the rotor is parallel and axial to the propelled airflow

DE 10 2005 046 796 A1 shows a cooling module for a motor vehicle with three heat exchangers positioned one after the other in the air flow direction. The heat exchangers are a charge air cooler, a refrigerant condenser, as well as a coolant cooler which is covered by the front surface of the condenser, whereas the charge air cooler only covers a subsection of the front surface of the condenser. The charge air cooler features laterally placed air boxes which are laterally carried past the condenser and the coolant cooler by means of air connectors.

DE 103 43 894 A1 discloses a fan of a cooling blower for at least one pressurized air chargeable heat exchanger of a motor vehicle. The fan is positioned downstream from the heat exchanger in the air flow direction. Accordingly, the fan takes in the cooling air through the heat exchangers prepositioned upstream from it, thereby generating a cooling air flow. When the motor vehicle is moving at a sufficiently high speed, the fan is switched off, so that the cooling module, or respectively, the coolant cooler, are charged and flooded with pressurized air. For these purposes, air passage apertures in the front surface of the hub are opened, so that that pressurized air can flow through. From the back side of the front surface of the hub, the air enters into the engine compartment, and from there into the surroundings of the motor vehicle.

DE 10 2004 043 354 A1 describes a device for mounting a heat exchanger, and in particular, a coolant cooler, onto a mounting support of a front end module for a motor vehicle, which is embodied as a frame. A coolant cooler embodied as a lateral flow cooler is arranged on the mounting support, which features two lateral coolant boxes, with pipes and ridges between them. A fan guard with a fan blower is connected behind the coolant cooler in the driving direction.

The cooling modules known from prior art are characterized by very large dimensions, in particular of height. The height here is the orientation vertical and perpendicular to the driving direction of the motor vehicle. The considerable height and the hardness of the cooling module in the frontal region of the motor vehicle complicate the compliance with the criteria for a requisite collision zone in terms of pedestrian protection.

Moreover, in particular in motor vehicles whose drive is positioned in the middle of the engine compartment or the rear, the necessary positioning of the cooling module in the frontal region of the motor vehicle requires extensive tubing of the coolant circulation system, which in turn increases the weight of the circulation system and therefore of the vehicle, specifically when the coolant circulation system is filled. The weight, in turn, affects the efficiency of the motor vehicle, in particular of electric vehicles.

The arrangement of the cooling module in the frontal region of the motor vehicle, and in particular, of the corresponding necessary cooling apertures in the frontal region, also affect the aerodynamics of the motor vehicle in its entirety, since the air for the cooling of the cooling module must enter into the engine compartment via the cooling apertures, and must exit the engine compartment again in an unguided manner.

The task of the invention is the provision of a compact cooling module for motor vehicles, in particular for the transfer of heat from a coolant circulating in a coolant circulation system to air. The cooling module should be capable of being arranged anywhere within the vehicle, preferably in the region of the heat-generating drive, and occupy a minimum amount of installation space, as well as being adjustable to the available installation space. The air mass flow required for the heat transmission should be capable of being taken in and of exiting at locations in the motor vehicle that do not impact the aerodynamics of the motor vehicle.

### SUMMARY OF THE INVENTION

The task is accomplished by the subject and the characteristics of the invention as shown and described herein.

The task is accomplished by a compact heat exchanger and blower unit for motor vehicles according to the invention. The heat exchanger and blower unit features a blower with an inlet and an outlet for the propulsion of an air mass flow, as well as a coolant-air heat exchanger with an air inlet and an air outlet for the transfer of heat between a coolant and the air mass flow.

According to the concept of the invention, the blower is embodied as a radial blower. Furthermore, the blower and the coolant-air heat exchanger are aligned with each other such that the air mass flow is propelled by the blower into the coolant-air heat exchanger. Consequently, the air flows into the blower, and is conducted to the coolant-air heat exchanger after exiting the blower.

According to a preferred embodiment of the invention, the air inlet of the coolant-air heat exchanger is designed on the front side with a width and a height dimension as side edges. In one air flow direction, the coolant-air heat exchanger also features a depth dimension. The aspect ratio between a side edge of the front surface and the depth is preferentially in the range of 0.2 to 1.0, and in particular in the range of 0.3 to 0.7. The coolant-air heat exchanger is therefore embodied with a front surface with smaller dimensions as compared to the larger depth dimension.

The air outlet of the coolant-air heat exchanger is advantageously embodied on the front side opposite of the front side with the air inlet, so that the air essentially flows through the coolant-air heat exchanger in a single direction.

According to a further development of the invention, the coolant-air heat exchanger features at least two coolant connections, and is embodied such that the coolant and the air flow through the coolant-air heat exchanger according to the counter-current principle.

According to an advantageous embodiment of the invention, the heat exchanger and blower unit features an enclosure element on the air-side connection of the blower outlet with the coolant-air heat exchanger air inlet.

The enclosure element is preferentially embodied as a diffuser, which steadily expands the flow area of the air from the blower outlet to the coolant-air heat exchanger air inlet.

The enclosure element preferentially features an aperture which can be opened or closed as a dynamic pressure opening as needed and depending on the operating mode of the heat exchanger and blower unit. It is advantageous that the aperture is oriented in the driving direction of the motor vehicle. By way of the opening of the aperture and the inflow of air from the surroundings into the driving motor vehicle into the coolant-air heat exchanger, the driving power of the blower can be reduced. The air mass flow channeled into the heat exchanger and blower unit through the aperture is channeled around the blower as a bypass flow.

According to a further development of the invention, the enclosure features an air inlet system with a dynamic pressure aperture in the region of the inlet, which is opened or closed as needed and depending on the operating mode of the heat exchanger and blower unit. It allows for the supply of dynamic air pressure to the blower, as a result of which the driving power of the blower is reduced as the driving speed of the motor vehicle increases.

A further preferential embodiment of the invention features an air inlet system in the intake region that is embodied as a system consisting of air valves, by way of which the heat exchanger and blower unit can be fully closed off on the air-side. In addition to the dynamic pressure aperture, the air inlet system advantageously also features an intake aperture.

The aperture in the enclosure element that is embodied as a dynamic pressure aperture for closing off the heat exchanger and blower unit and/or the dynamic pressure aperture in the region of the inlet of the air inlet system of the blower and/or the intake aperture advantageously feature a flow-channeling device, each of which is driven by a respective adjustment element. The flow-channeling devices can preferentially be set in many positions, preferentially in stepless positions, whereby the dynamic pressure apertures or the intake aperture, respectively, are closed by the flow-channeling device in a first end position, and opened in another end position. Depending on the need and on the operating mode or the operating position of the heat exchanger and blower unit, any interim position between the two end positions is possible.

The flow-channeling devices are advantageously embodied in the form of a valve, which is rotationally arranged around an axis. The valves are borne by bearings that are located in the enclosure element or in the enclosure. Furthermore, the valves preferentially feature a surrounding seam, which corresponds with the sealing flange surfaces in the enclosure element or in the enclosure, and which guarantee a gas-tight sealing of the apertures.

According to a further development of the invention, the blower and the coolant-air heat exchanger are aligned with respect to each other such that the air mass flow exiting from the outlet of the blower is diverted at an angle in order to enter into the inlet of the coolant-air heat exchanger. By means of this alignment at an angle and this orientation of the blower in relation to the coolant-air heat exchanger, the heat exchanger and blower unit can be adjusted to the available installation space.

According to a first alternative embodiment of the invention, the measurements of the heat exchanger and blower unit in a dimension x and a dimension z, which are perpendicular to each other, have identical values. The air flows here through the coolant-air heat exchanger in a dimension z. Identical measurement values in the dimensions x and z should be understood to mean that the values are approximately equally large, and at least within the same order of magnitude. The ratio between the measurement values is in the range of 0.8 to 1.4.

According to a second alternative embodiment of the invention, the measurements of the heat exchanger and blower unit in a dimension z have greater values than those in a dimension x, which are perpendicular to each other, have identical values. Here too, the air flows through the coolant-air heat exchanger in a dimension z. The ratio between the measurement values is greater than 1.4.

According to an advantageous embodiment of the invention, the compact heat exchanger and blower unit consists of one or several enclosure components, in which the blower and the coolant-air heat exchanger are arranged. The inlet and the outlet of the blower and the air inlet of the coolant-air heat exchanger are integrated in the enclosure component(s). Furthermore, preferentially, all air channels, such as the aperture between the blower outlet and the air inlet of the coolant-air heat exchanger which is embodied as a dynamic pressure aperture, and/or the air inlet system in the region of the blower inlet featuring the dynamic pressure aperture, which can be opened or closed as needed or based on the operating mode of the coolant-air heat exchanger, respectively, and/or the system of air valves, through which the heat exchanger and blower unit can be completely closed off on the air-side, are embodied inside the enclosure element(s).

In summary, the compact heat exchanger and blower unit according to the invention, also referred to as a compact cooling module, has various advantages:
a free and independent arrangement inside the motor vehicle, in particular in the region of the cooled engine, as well as adjustment to the available installation space;
a reduction of the installation space and of the weight, among other things due to the minimization of tube length and coolant volume as a result of the targeted arrangement inside the motor vehicle, as compared to the cooling methods known from prior art;
minimal production, assembly, and maintenance costs;
the direct propulsion of the air mass flow in the coolant-air heat exchanger by the radial blower, with a resulting reduction of the air throughput without loss of performance of the cooling module, and/or higher pressures with the same air throughput as compared to the use of an axial blower;
improved aerodynamics inside and around the coolant-air heat exchanger; and
improved protection for pedestrians.

### BRIEF DESCRIPTION OF THE DRAWINGS

Further details, characteristics, and advantages of embodiments of the invention follow from the following description of exemplary embodiments, in reference to the respective drawings. A blower and a coolant-air heat exchanger of a heat exchanger and blower unit are shown in:

FIGS. 1, 2A, 2B: in a compact arrangement relative to each other with an enclosure element for an air-side connection of the blower and the coolant-air heat exchanger as a connector component;

FIGS. 3A, 3B: in a directly connected arrangement without a connector component; and

FIGS. 4A, 4B: in an enclosure element functioning as a diffuser for an air-side connection between the blower and the coolant-air heat exchanger as a connector component.

### DESCRIPTION OF SPECIFIC EMBODIMENTS

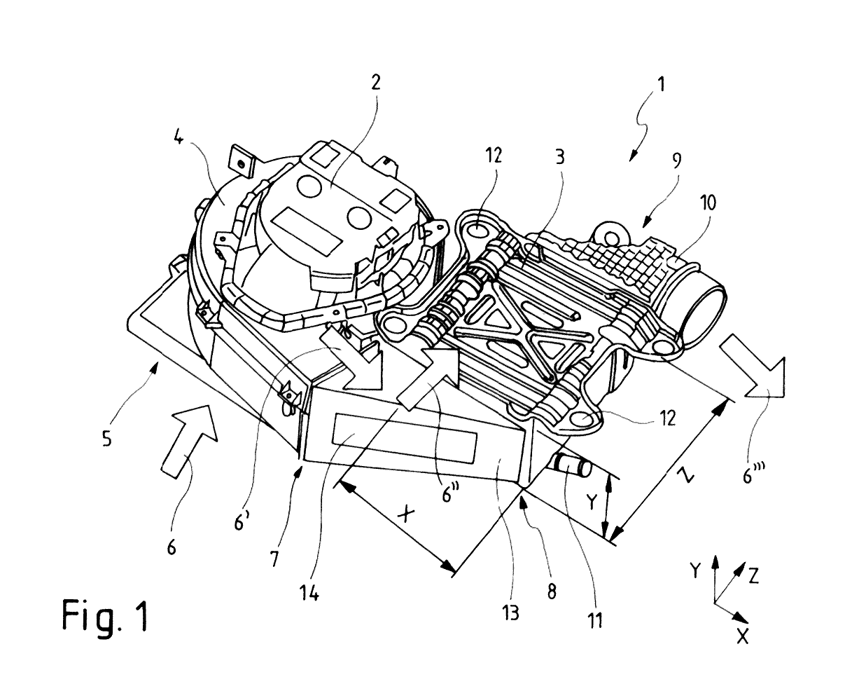

FIG. 1 shows a heat exchanger and blower unit 1 with a blower 2, a coolant-air heat exchanger 3, and an enclosure element 13 for an air-side connection of the blower 2 and the coolant-air heat exchanger 3 as a connector component in its assembled state, in a compact arrangement relative to each other.

The propelled air mass flow is taken in by an electrically powered blower wheel through an inlet 5 in an enclosure 4 in air flow direction 6 into the enclosure 4. As a result of the movement of the blower wheel, the air flows axially along a rotational axis into the blower wheel, and exits the blower wheel radially into an air channel located inside the enclosure 4. Accordingly, the air mass flow is taken in in parallel to the rotational axis, diverted by 90° due to the rotation of the blower wheel, and blown out of it radially. The air is taken in directly by the heat exchanger and blower unit 1.

In the embodiment of the blower 2 as a compact radial blower with a spiral enclosure 4, the air is propelled in flow direction 6′ out of the enclosure 4 through an outlet 7. In order to minimize the pressure losses caused by the high exit speed of the air mass flow from the enclosure 4, the air channel for conducting the air mass flow to the heat exchanger 3 may, for example, be embodied as a diffuser.

Through the embodiment of the blower 2 as a radial blower rather than a conventional axial blower, the necessary air throughput for the same performance of the heat exchanger and blower unit 1 can be reduced. The use of the radial blower as compared to the use of an axial blower achieved higher pressure results at an identical air throughput, in order to overcome the correspondingly increased counter pressures.

The enclosure element 13 connects the outlet 7 of the blower 2 with the air inlet 8 of the coolant-air heat exchanger 3. An air channel enclosed by the enclosure element 13 is limited by a closed upper side and a closed underside, which extend in the plane defined by the dimensions x and z, and which are offset from each other in the dimension y. The open side edges of the enclosure element 13 are adjacent to the outlet 7 of the blower 2 and at the air inlet 8 of the coolant-air heat exchanger 3.

A third side edge of the enclosure element 13 features an aperture 14, which can be opened or closed as a dynamic pressure opening as needed and depending on the operating mode of the heat exchanger and blower unit 1. The aperture 14 is located in the region of the diffuser of the blower 2. The aperture 14 is advantageously oriented in the driving direction of the motor vehicle.

On the one hand, when the dynamic pressure is low, the air mass flow propelled by the blower 2 could exit at least in part from the aperture 14. On the other hand, by opening the aperture 14, the driving power of the blower 2 in a driving motor vehicle can be reduced. When the dynamic pressure is sufficiently high, the blower 2 may even be switched off entirely, and due to the positioning of the aperture 14 directly near the air inlet 8 of the coolant-air heat exchanger 3, an air mass flow with a low pressure loss is channeled into the coolant-air heat exchanger 3.

The aperture embodied in the enclosure element 13 as a dynamic pressure aperture features a flow-channeling device which is not shown here, which is driven by an adjustment element. The flow-channeling device can be steplessly adjusted. The dynamic pressure aperture is closed here by the flow-channeling device in a first end position, and opened in another end position.

The flow-channeling device may exemplarily be embodied in the form of a valve, which is rotationally arranged around an axis and which is borne by bearings that are located in the enclosure element 13. Furthermore, the valve features a surrounding seam, which corresponds with the sealing flange surfaces in the enclosure element 13, and which guarantee a gas-tight sealing of the aperture 14.

According to an embodiment not shown here, a dynamic pressure aperture is embodied in the intake region of the air mass flow into the heat exchanger and blower unit 1. The blower 2 therefore features an air intake system with a dynamic pressure aperture in the region of the inlet 5, which can be opened or closed as needed and depending on the operating mode of the heat exchanger and blower unit 1. By opening the dynamic pressure aperture, the dynamic pressure aperture would ensure the inflow of additional air from the surroundings even when the blower 2 is operating. The inflow of pressured air through the inlet 5 of the blower 2 reduces the driving power of the blower 2, specifically when the motor vehicle is driving at high speed.

The air mass flow propelled by the blower 2 flows in the air flow direction 6″ through the air inlet 8 into the coolant-air heat exchanger 3. The air inlet 8 is located on the front side of the coolant-air heat exchanger 3, which is defined by the width X and the height Y. The air then flows in the depth direction Z through the coolant-air heat exchanger 3, and exits via the air outflow 9 located opposite from the air inlet 8 on the front side.

On the one hand, the front surface defined by the width X and the height Y is very small, in comparison with the coolant-air heat exchangers known from prior art. On the other hand, the depth Z, specifically with values greater than or equal to 25 mm, is very large in comparison with the coolant-air heat exchangers known from prior art. The ratio between an edge of the front surface, either the width X or the height Y, and the depth Z of the coolant-air heat exchanger 3 is in the range of 0.2 to 1.0, and specifically in the range of 0.3 to 0.7.

For a focused targeting of the air mass flow exiting from the coolant-air heat exchanger 3, an additional enclose element 10 is arranged at the air outflow 9. When flowing through the enclose element 10, the air mass flow is diverted and exits the heat exchanger and blower unit 1 in air flow direction 6″.

The coolant that is cooled by the air mass flow enters into the coolant-air heat exchanger 3 via the first coolant connection 11, and exits via a second coolant connection that is not shown. The coolant and the air flow through the coolant-air heat exchanger 3 according to the counter-current principle in order to achieve a maximum effectiveness.

The heat exchanger and blower unit 1, and in particular, the coolant-air heat exchanger 3, are fastened by means of fastening elements 12 in the motor vehicle. The fastening elements 12 are preferentially embodies as grommets.

According to a further embodiment that is not shown here, the air inlet system of the heat exchanger and blower unit 1 features a system consisting of air valves, by way of which the heat exchanger and blower unit 1 can be fully closed off on the air-side. The air inlet system therefore consists of an inlet aperture in addition to the dynamic pressure aperture.

The closing of the heat exchanger and blower unit 1 on the air-side is advantageous in particular in electric vehicles with a battery cooling system and in using the waste heat of engine components for a heat pump system or a battery heating system in order to prevent any heat losses in the system, in particular in electric vehicles at low temperatures.

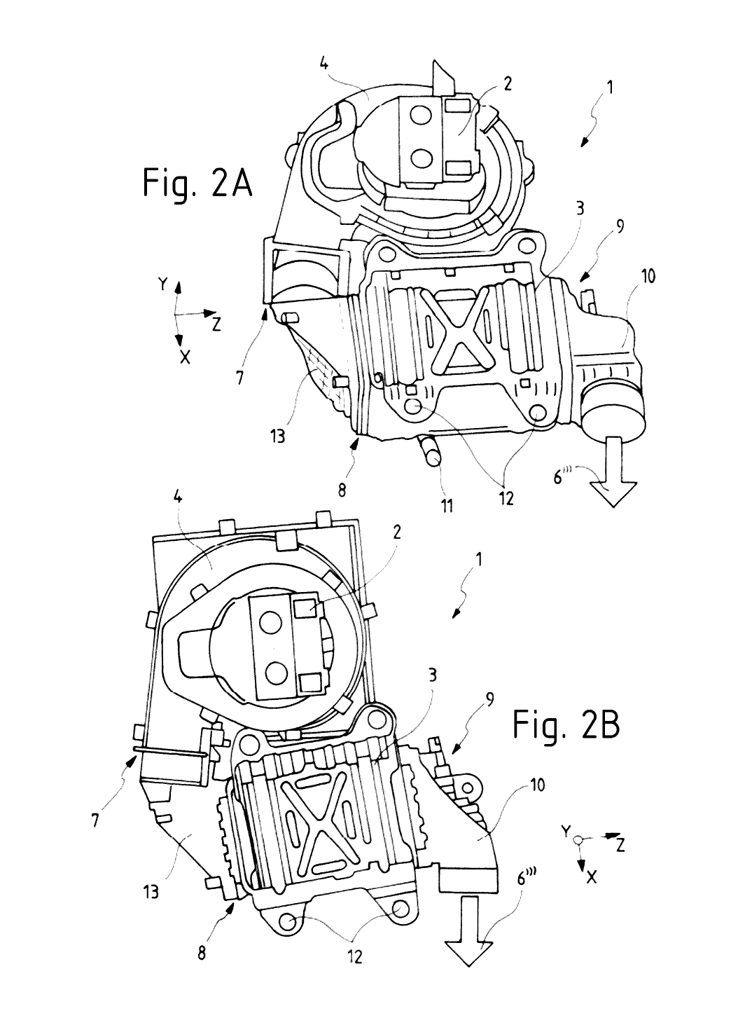

In FIGS. 2A and 2B, the heat exchanger and blower unit 1 is shown with the blower 2 and the coolant-air heat exchanger 3 in a compact arrangement relative to each other with an enclosure element 13 for an air-side connection of the blower 2 and the coolant-air heat exchanger 3 as a connector component, similar to embodiment according to FIG. 1B.

The blower 2 and the coolant-air heat exchanger 3 are arranged such relative to each other that the air mass flow exiting from the blower 2 is diverted at an angle in the range of 75° to 90° when flowing through the enclosure element 13, and specifically, at an angle of approx. 85°.

The arrangement of the blower 2 and the coolant-air heat exchanger 3 allows for a compact heat exchanger and blower unit 1 which occupies only a limited amount of installation space, in particular in terms of its width X, and of which the width X and the depth Z have similar values.

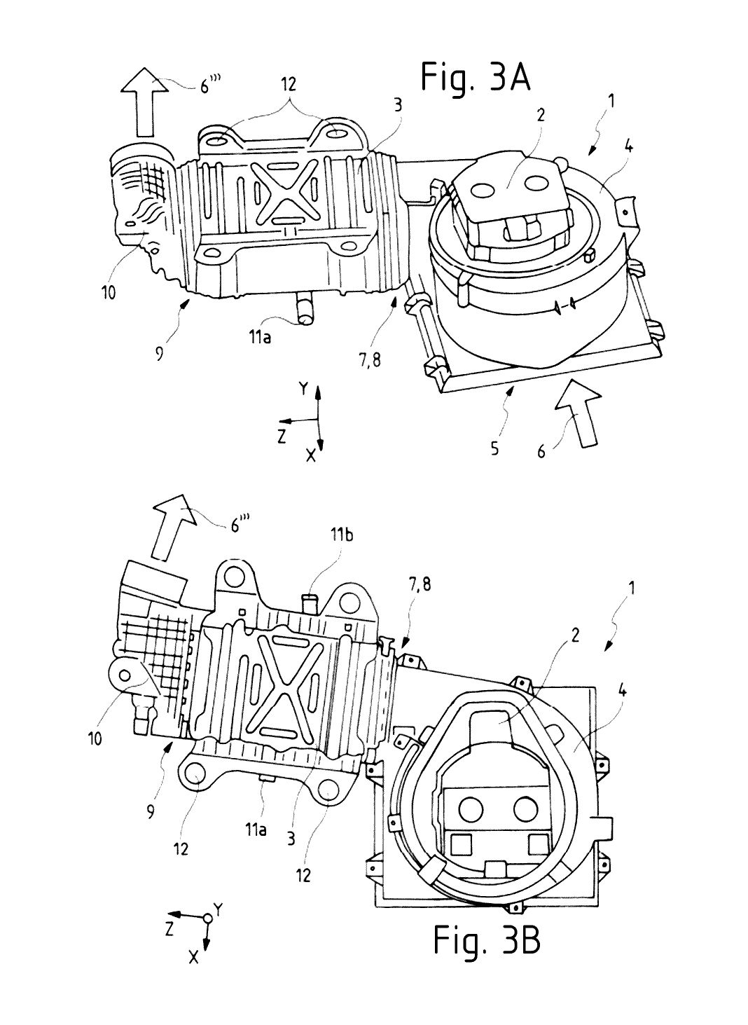

FIGS. 3A and 3B show the heat exchanger and blower unit 1, with the blower 2 and the coolant-air heat exchanger 3 in a directly connected arrangement without a connector component. A directly connected arrangement should be understood as the air-side connection of the blower 2 with the coolant-air heat exchanger 3 in which the outlet 7 of the blower 2 is directly connected with the air inlet 8 of the coolant-air heat exchanger 3.

The air mass flow exiting from the blower 2 is channeled without further detours into the coolant-air heat exchanger 3, which minimizes the possibility of pressure losses.

The coolant connections 11a, 11b are arranged on the respectively opposing side surfaces of the coolant-air heat exchanger 3. While the air mass flow essentially flows in the dimension z through the coolant-air heat exchanger 3, the coolant is channeled essentially in the dimension x through the coolant-air heat exchanger 3, thereby implementing the counter-current principle.

The arrangement of the blower 2 and the coolant-air heat exchanger 3 makes possible a compact heat exchanger and blower unit 1, the largest dimension of which is the depth Z.

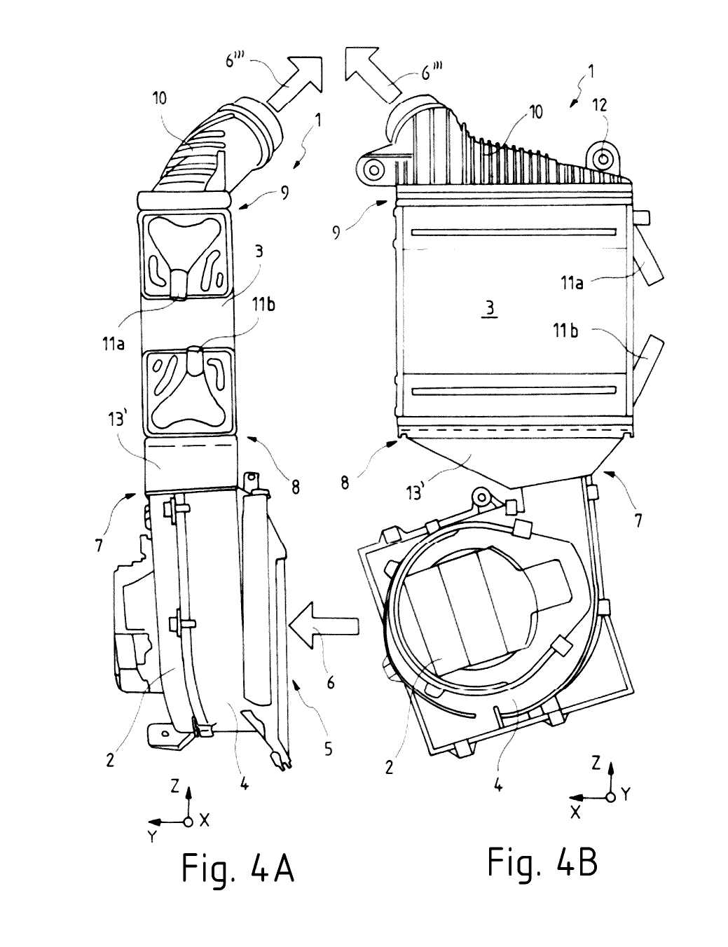

FIGS. 4A and 4B show the heat exchanger and blower unit 1 with the blower 2 and the coolant-air heat exchanger 3 as well as an enclosure element 13′ which functions as a diffuser for an air-side connection between the blower 2 and the coolant-air heat exchanger 3 as a connecting component.

The blower 2 and the coolant-air heat exchanger 3 are arranged such with respect to each other that the speed of the air mass flow exiting the blower 2 is lowered when it flows through the enclosure element 13′, and that the pressure is increased. The enclosure element 13′ is embodied such that the flow area of the air mass flow expands steadily, and that the flow areas of the outlet 7 of the blower 2 and of the air inlet 8 of the coolant-air heat exchanger 3 are consequently corresponding. The air mass flow is not diverted when it flows through the enclosure element 13′, which minimized the possibility of pressure losses.

The coolant connection 11a, 11b are arranged on a shared side edge of the coolant-air heat exchanger 3. As in the previously mentioned embodiments, the coolant-air heat exchanger 3 is preferentially operated according to the counter-current principle, such that the air mass flow essentially flows through the coolant-air heat exchanger 3 in the dimension z, and the coolant essentially flows through it in the dimension x.

The arrangement of the blower 2 and the coolant-air heat exchanger 3 allows for a compact heat exchanger and blower unit 1 which occupies only a limited amount of installation space, in particular in terms of its width X, and in which the depth Z measurements have the greatest value.

In all embodiments, the blower 2 and the coolant-air heat exchanger 3 are essentially arranged in the plane defined by the dimensions x and z. The air is taken in by the inlet 5 of the blower 2 in the air flow direction 6, and therefore in the dimension y. It is then channeled across the plane defined by the dimensions x and z through the heat exchanger and blower unit 1, and discharged in the air flow direction 6″, which essentially is in the dimension x. All heat exchanger and blower units 1 feature a similar height Y.

According to an embodiment not shown here, the blower 2 is exemplarily arranged in the plane defined by the dimensions x and z, whereas the coolant-air heat exchanger 3 is either arranged in the plane defined by the dimensions y and z, or in the plane defined by the dimensions x and y. In such cases, the air mass flow exiting from the blower 2 is diverted at an angle of 90° when it flows through an enclosure element fluidically connecting the outlet 7 of the blower 2 and the air inlet 8 of the coolant-air heat exchanger 3. Depending on the arrangement of the blower 2 and the coolant-air heat exchanger 3 with respect to each other, the angle may also be in the range of 0° to 90°.

### REFERENCE LIST

1 compact heat exchanger and blower unit
2 blower
3 coolant-air heat exchanger
4 enclosure of blower 2
5 inlet of blower 2
6, 6′, 6″, 6′″ air mass flow direction
7 outlet of blower 2
8 air inlet of the coolant-air heat exchanger 3
9 air outlet of the coolant-air heat exchanger 3
10 enclosure element of air outlet 9
11, 11a, 11b coolant port of the coolant-air heat exchanger 3
12 fastening element
13, 13′ enclosure element for the air-side connection of blower 2 and the coolant-air heat
exchanger 3
14 opening in the enclosure element 13—dynamic pressure aperture
x, y, z dimensions
X width of the coolant-air heat exchanger 3
Y height of the coolant-air heat exchanger 3
Z depth of the coolant-air heat exchanger 3

What is claimed is:

1. A compact heat exchanger and blower unit for motor vehicles, the heat exchanger and blower unit comprising:
a blower for propulsion of an air mass flow, the blower having an inlet and an outlet);
a coolant-air heat exchanger for heat transfer between a coolant and the air mass flow, the coolant-air heat exchanger having an air inlet and an air outflow, wherein the blower is a radial blower, and wherein the blower and the coolant-air heat exchanger are aligned with respect to each other such that the air mass flow is propelled by the blower into the coolant-air heat exchanger.

2. The heat exchanger and blower unit according to claim 1, wherein the air inlet of the coolant-air heat exchanger includes on a front side a width (X) dimension and a height (Y) dimension as side edges, and in one air flow direction (z), the coolant-air heat exchanger includes a depth (Z) dimension, wherein an aspect ratio between a first side edge of the front side and the depth (Z) is in a range of 0.2 to 1.0.

3. The heat exchanger and blower unit according to claim 1, wherein the coolant-air heat exchanger includes coolant connections, and wherein the coolant and air flow through the coolant-air heat exchanger according to a counter-current principle.

4. The heat exchanger and blower unit according to claim 1, further comprising an enclosure element for an air-side connection of the outlet of the blower with the air inlet of the coolant-air heat exchanger.

5. The heat exchanger and blower unit according to claim 4, wherein the enclosure element is a diffuser extending a flow area of air from the outlet of the blower to the air inlet of the coolant-air heat exchanger.

6. The heat exchanger and blower unit according to claim 4, wherein the enclosure element includes an aperture opened or closed as a dynamic pressure opening depending on an operating mode of the heat exchanger and blower unit.

7. The heat exchanger and blower unit according to claim 1, wherein the blower includes an air inlet system with a dynamic pressure aperture in a region of the inlet, the dynamic pressure aperture opened or closed depending on an operating mode of the heat exchanger and blower unit.

8. The heat exchanger and blower unit according to claim 1, further comprising a system consisting of air valves, by way of which the heat exchanger and blower unit can be fully closed off on an air side.

9. The heat exchanger and blower unit according to claim 8, wherein the system consisting of air valves is a part of an air inlet system in an intake region and includes an intake aperture.

10. The heat exchanger and blower unit according to claim 1, further comprising a dynamic pressure aperture or an intake aperture including a flow-channeling device driven by an adjustment element, which can be set steplessly in various positions, wherein the dynamic pressure aperture or the intake aperture is closed by the flow-channeling device in a first end position and opened in a second end position.

11. The heat exchanger and blower unit according to claim 10, wherein the flow-channeling device is a valve rotationally arranged around an axis, the valve borne by bearings disposed in an enclosure element or an enclosure.

12. The heat exchanger and blower unit according to claim 1, wherein dimensions of the heat exchanger and blower unit in a dimension x and a dimension z perpendicular to each other have identical values, air flowing through the coolant-air heat exchanger in the dimension z.

13. The heat exchanger and blower unit according to claim 1, wherein dimensions of the heat exchanger and blower unit in a dimension z has a greater value than in a dimension x, the dimension z and the dimension x perpendicular to each other, air flowing through the coolant-air heat exchanger in the dimension z.

14. The heat exchanger and blower unit according to claim 1, further comprising an enclosure component in which the blower and the coolant-air heat exchanger are arranged, the inlet and the outlet of the blower and the air inlet of the coolant-air heat exchanger integrated into the enclosure component.
